(19) United States
(12) Patent Application Publication
(10) Pub. No.: US 2012/0045697 A1
(43) Pub. Date: Feb. 23, 2012

(54) ELECTROLYTE FOR RECHARGEABLE LITHIUM BATTERY, AND RECHARGEABLE LITHIUM BATTERY INCLUDING SAME

(75) Inventors: Na-Rae PARK, Yongin-si (KR); Jin-Hyunk LIM, Yongin-si (KR); Su-Hee HAN, Yongin-si (KR); Mi-Hyeun OH, Yongin-si (KR); Eun-Gi SHIM, Gongju-si (KR)

(73) Assignees: TECHNO SEMICHEM CO., LTD., Seongnam-si (KR); SAMSUNG SDI CO., LTD., Yongin-si (KR)

(21) Appl. No.: 13/209,554

(22) Filed: Aug. 15, 2011

(30) Foreign Application Priority Data
Aug. 23, 2010 (KR) 10-2010-0081493

(51) Int. Cl. H01M 10/056

(52) U.S. Cl. 429/328; 429/336; 429/339; 429/330; 429/334

(57) ABSTRACT

Disclosed are an electrolyte for a rechargeable lithium battery that includes a lithium salt, a non-aqueous organic solvent, and an additive including a triazine-based compound represented by the following Chemical Formula 1 and fluoroethyl carbonate, and a rechargeable lithium battery including the electrolyte.

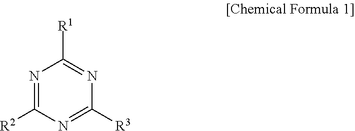

where R¹, R², and R³ are the same as described in the detailed description.

### RELATED APPLICATIONS

This application claims priority to and the benefit of Korean Patent Application No. 10-2010-0081493 filed in the Korean Intellectual Property Office on Aug. 23, 2010, the entire contents of which are incorporated herein by reference.

### BACKGROUND

1. Field

This disclosure relates to an electrolyte for a rechargeable lithium battery and a rechargeable lithium battery including the same.

2. Description of the Related Art

Lithium rechargeable batteries have recently drawn attention as a power source for small portable electronic devices. They use an organic electrolyte solution and thereby have twice the discharge voltage of a conventional battery using an alkali aqueous solution, and accordingly have high energy density.

This rechargeable lithium battery is used by injecting an electrolyte into a battery cell including a positive electrode including a positive active material that can intercalate and deintercalate lithium, and a negative electrode including a negative active material that can intercalate and deintercalate lithium.

Lithium ions, which are released from a lithium metal oxide of a positive electrode, are transferred to a negative electrode and intercalated therein. Because of their high reactivity, lithium ions react with carbon compounds in a negative electrode to produce Li₂CO₃, LiO, LiOH, etc., thereby forming a thin film on the surface of the negative electrode.

In a thin prismatic rechargeable lithium battery, CO, CO₂, CH₄, C₂H₆, and the like are generated from decomposition of a non-aqueous organic solvent during the film formation reaction, and therefore the battery thickness may be increased during charge. During full-charged storage at a high temperature, such a film may collapse as time passes, and a side-reaction between an electrolyte and a negative electrode may occur. Therefore, continuous gas generation may increase the pressure inside the battery.

### SUMMARY

One aspect of the present invention provides an electrolyte for a rechargeable lithium battery that may suppress a thickness increase of a rechargeable lithium battery when it is stored at a high temperature and show excellent cycle-life characteristics.

Another aspect of the present invention provides a rechargeable lithium battery including the electrolyte.

One aspect of the present invention provides an electrolyte for a rechargeable lithium battery that includes a lithium salt, a non-aqueous organic solvent, and an additive including a triazine-based compound represented by the following Chemical Formula 1 and fluoroethyl carbonate.

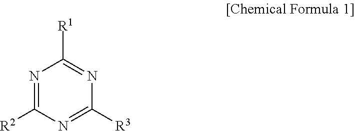

wherein R¹, R², and R³ are the same or different from each other, and are hydrogen, halogen, a substituted or unsubstituted C1 to C20 alkyl group, or a substituted or unsubstituted C1 to C20 haloalkyl group.

Another aspect of the present invention provides a rechargeable lithium battery that includes: a positive electrode; a negative electrode; and an electrolyte including a lithium salt, a non-aqueous organic solvent, and an additive including a triazine-based compound represented by the above Chemical Formula 1 and fluoroethyl carbonate.

In Chemical Formula 1, R¹, R², and R³ may be independently a C1 to C20 perfluoroalkyl group, and the triazine-based compound represented by the above Chemical Formula 1 may include 2,4,6-tris(trifluoromethyl)-1,3,5-triazine, 2,4,6-tris(trichloromethyl)-1,3,5-triazine, or a combination thereof.

The triazine-based compound represented by the above Chemical Formula 1 may be included in an amount of about 0.1 wt % to about 5 wt % based on the total weight of the electrolyte, and the fluoroethyl carbonate may be included in an amount of about 0.1 wt % to about 15 wt % based on the total weight of the electrolyte.

The non-aqueous organic solvent may include a linear carbonate in an amount of about 60 wt % or more based on the total weight of the non-aqueous organic solvent, and a cyclic carbonate in an amount of about 40 wt % or less than based on the total weight of the non-aqueous organic solvent.

The negative electrode includes a current collector and a negative active material layer including a negative active material disposed on the current collector, and the negative active material may include a carbon-based compound.

Hereinafter, further embodiments will be described in detail.

When using the electrolyte for a rechargeable lithium battery, a rechargeable lithium battery being capable of suppressing a thickness increase during storage at a high temperature and showing excellent cycle-life characteristics may be provided.

### BRIEF DESCRIPTION OF THE DRAWINGS

FIG. 1 is a schematic view of a rechargeable lithium battery according to one embodiment of the present invention.

FIG. 2 is a graph showing cycle life of rechargeable lithium battery cells using the electrolytes according to Example 1 and Comparative Examples 1 to 4.

### DETAILED DESCRIPTION

Exemplary embodiments will hereinafter be described in detail. However, these embodiments are only exemplary, and the present invention is not limited thereto.

As used herein, when other specific description is not provided, the term “substituted” may refer to one substituted with halogen, a hydroxy group, a C1 to C20 alkyl group, a C2 to C20 alkenyl group, a C₂ to C20 alkynyl group, a C1 to C20 alkoxy group, a C3 to C30 cycloalkyl group, a C3 to c30 cycloalkenyl group, a C3 to C30 cycloalkynyl group, a C2 to C30 heterocycloalkyl group, a C2 to C30 heterocycloalkenyi group, a C2 to C30 heterocycloalkynyl group, a C6 to C30 aryl group, a C6 to C30 aryloxy group, a C2 to C30 heteroaryl group, an amine group (—NR′R″, wherein R′ and R″ are the same or different from each other, and are hydrogen, a C1 to C20 alkyl group, or a C6 to C30 aryl group), an ester group (—COOR′″, wherein R′″ is hydrogen, a C1 to C20 alkyl group, or a C6 to C30 aryl group), a carboxyl group (COOH), a nitro group (—NO₂), or a cyano group (—CN) instead of at least one hydrogen.

As used herein, when a specific definition is not otherwise provided, the term “alkyl group” may refer to a C1 to C20 alkyl group, and “haloalkyl group” may refer to an alkyl group substituted with halogen of F, Cl, Br or I instead of at least one hydrogen.

The electrolyte for a rechargeable lithium battery according to one embodiment includes a lithium salt, a non-aqueous organic solvent, and an additive.

The additive includes a triazine-based compound represented by the following Chemical Formula 1 and fluoroethyl carbonate.

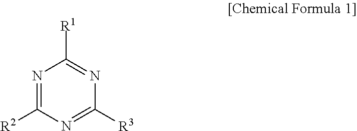

wherein,

R¹, R², and R³ are the same or different from each other, and are hydrogen, halogen, a substituted or unsubstituted C1 to C20 alkyl group, or a substituted or unsubstituted C1 to C20 haloalkyl group.

In Chemical Formula 1, R¹, R², and R³ may be a C1 to C20 perfluoroalkyl group.

The triazine-based compound represented by the above Chemical Formula 1 may include 2,4,6-tris(trifluoromethyl)-1,3,5-triazine, 2,4,6-tris(trichloromethyl)-1,3-triazine, and the like, and may be used singularly or as a mixture thereof.

The triazine-based compound represented by Chemical Formula 1 may be included at about 0.1 wt % to about 5 wt %, or for example, at about 1 to about 3 wt % based on the total amount of electrolyte. When the triazine-based compound is included within the range of about 0.1 wt % to about 5 wt %, it may provide an excellent cycle-life characteristic while preventing the thickness increase of the rechargeable lithium battery while being allowed to stand at a high temperature, as well as a room temperature cycle-life characteristic.

The fluoroethyl carbonate may be included at about 0.1 wt % to about 15 wt %, or for example, at about 5 wt % to about 10 wt % based on the total amount of electrolyte. When the fluoroethyl carbonate is included within the range, it may suppress the thickness increase of the rechargeable lithium battery and provide an excellent cycle-life characteristic while being allowed to stand at a high temperature, as well as a room temperature cycle-life characteristic. In especially, the fluoroethyl carbonate may form a stable SEI (solid electrolyte interface) layer on a surface of the negative electrode during initial charge, thereby maintaining the initial thickness of the battery and improving cycle-life characteristics, rather than other haloalkyl carbonate.

In addition, the triazine-based compound and the fluoroethyl carbonate may be mixed at a weight ratio of 1:1 to 5. When it is mixed within the ratio range, it may suppress the thickness increase of the rechargeable lithium battery and provide an excellent cycle-life characteristic while being allowed to stand at a high temperature, as well as a room temperature cycle-life characteristic.

When the additive is used in the rechargeable lithium battery, it may suppress the thickness increase of the rechargeable lithium battery and provide an excellent cycle-life characteristic while being allowed to stand at a high temperature, so that it may enhance the reliability of mounting a battery set particularly when it is used in a prismatic rechargeable lithium battery. The additive may be reacted with the positive electrode to suppress gas generation caused by reaction of the positive electrode with the electrolyte while being allowed to stand at a high temperature, so as to prevent the thickness increase due to the gas generation.

The lithium salt dissolved in the non-aqueous solvent supplies lithium ions in the battery, and operates a basic operation of a rechargeable lithium battery and improves lithium on transport between positive and negative electrodes.

Examples of the lithium salt include at least one supporting salt selected from LiPF₆, LiBF₄, LiSbF₆, LiAsF₆, LiN(SO₃C₂F₅)₂, LiC₄F₉SO₃, LiClO₄, LiAClO₂, LiAlCl₄, LiN(CₓF₂ₓ₊₁SO₂)(C_{y}F₂₊₁SO₂) where x and y are natural numbers, LiCl, LiB(C₂O₄)₂ (lithium bis(oxalato) borate: LiBOB), or a combination thereof.

The lithium salt may be used at about a 0.1M to about a 2.0M concentration. When the lithium salt is included at the above concentration range, electrolyte performance and lithium ion mobility may be enhanced due to optimal electrolyte conductivity and viscosity.

The non-aqueous organic solvent acts as a medium for transmitting ions taking part in the electrochemical reaction of the battery. The non-aqueous organic solvent may include a carbonate-based compound, an ester-based compound, an ether-based compound, a ketone-based compound, an alcohol-based compound, an aprotic solvent, or a combination thereof.

/The carbonate-based compound may include a linear carbonate compound, a cyclic carbonate compound, or a combination thereof.

The linear carbonate compound may include diethyl carbonate (DEC), ethylmethyl carbonate (EMC), dimethyl carbonate (DMC), dipropyl carbonate (DPC), methylpropyl carbonate (MPC), ethylpropyl carbonate (EPC), methylethyl carbonate (MEC), or a combination thereof, and the cyclic carbonate compound may include ethylene carbonate (EC), propylene carbonate (PC), butylene carbonate (BC), or a combination thereof.

The linear carbonate compound may be added at more than about 60 wt % based on the total amount of the non-aqueous organic solvent, and the cyclic carbonate compound may be added at about 40 wt % or less than based on the total amount of the non-aqueous organic solvent. When the linear carbonate compound and the cyclic carbonate compound are respectively included within the range, it may provide a solvent having a high dielectric constant and simultaneously low viscosity.

The ester-based compound may include methylacetate, ethylacetate, n-propylacetate, dimethylacetate, methylpropionate, ethylpropionate, γ-butyrolactone, decanolide, valerolactone, mevalonolactone, caprolactone, and the like. The ether-based compound may include dibutylether, tetraglyme, diglyme, dimethoxyethane, 2-methyltetrahydrofuran, tetrahydrofuran, and the like, and the ketone-based compound may include cyclohexanone and the like. The alcohol-based compound may include ethanol, isopropyl alcohol, and the like.

The non-aqueous organic solvent may be used singularly or as a mixture. When the organic solvent is used as a mixture, the mixture ratio may be controlled in accordance with desirable battery performance.

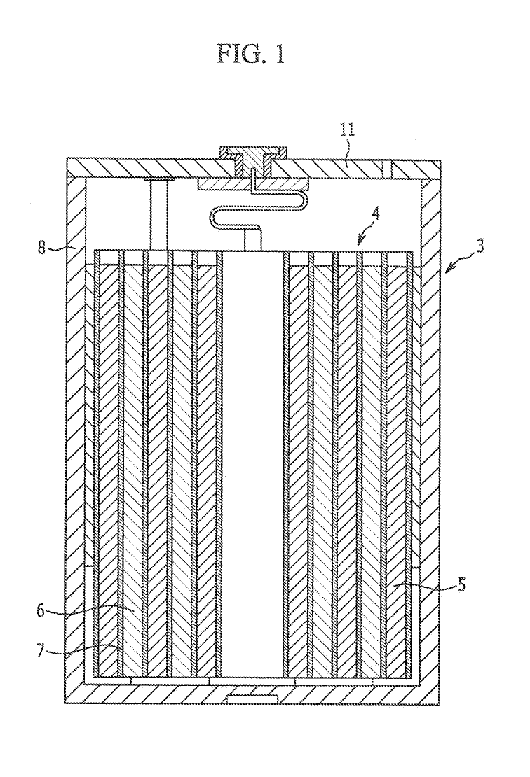

Referring to FIG. 1, the rechargeable lithium battery according to another embodiment is described.

FIG. 1 is a schematic view of a representative structure of rechargeable lithium battery according to one embodiment.

Referring to FIG. 1, the rechargeable lithium battery 3 is a prismatic battery that includes an electrode assembly 4 in a battery case 8, an electrolyte implanted through the upper portion of the case 8, and a cap plate 11 sealing the case 8. The electrode assembly 4 includes a positive electrode 5, a negative electrode 6, and a separator 7 positioned between the positive electrode 5 and the negative electrode 6. The rechargeable lithium battery of the present invention is not limited to a prismatic type of rechargeable lithium battery, and it may be formed in diverse forms such as a cylindrical form, a coin-type form, or a pouch form as long as it includes the electrolyte for a rechargeable lithium battery and operates as in a battery.

The electrolyte is the same as described above.

The positive electrode 5 includes a current collector and a positive active material layer disposed on the current collector. The positive active material layer includes a positive active material, a binder, and a conductive material.

The current collector may include Al (aluminum), but is not limited thereto.

The positive active material includes lithiated intercalation compounds that reversibly intercalate and deintercalate lithium ions. The positive active material may include a composite oxide including at least one selected from the group consisting of cobalt, manganese, and nickel, as well as lithium. In one embodiment, the following lithium-containing compounds may be used, but is not limited thereto:

LiₐA_{1-b}R_{b}D₂ (wherein 0.90≦a≦1.8 and 0≦b≦0.5); LiₐE_{1-b}R_{b}O_{2-c}D_{c} (wherein 0.90≦a≦1.8, 0≦b≦0.5, and 0≦c≦0.05); LiₐE_{2-b}R_{b}O_{4-c}D_{c} (wherein 0.90≦a≦1.8, 0≦b≦0.5 and 0≦c≦0.05); LiₐNi_{1-b-c}Co_{b}R_{c}Dₐ, (wherein 0.90≦a≦1.8, 0≦b≦0.5, 0≦c≦0.05, and 0<a≦2); Li_{1-b-c}Co_{b}R_{c}Dₐ (wherein 0.90≦a≦1.8, 0≦b≦0.5, 0≦c≦0.05, and 0<a<2); LiₐNi_{1-b-c}CO_{b}R_{c}O₂₋ₐZ₂ (wherein 0.90≦a≦1.8, 0≦b≦0.5, 0≦c≦0.05, and 0<a<2); LiₐNi_{1-b-c}Mn_{b}R_{c}Dₐ (wherein 0.90≦a≦1.8, 0≦b≦0.5, 0≦c≦0.05, and 0<a≦2); LiₐNi_{1-b-c}Mn_{b}R_{c}O₂₋ₐZₐ (wherein 0.90≦a1.8, 0≦b≦0.5, 0≦c≦0.05, and 0<a<2); LiₐNi_{1-b-c}Mn_{b}R_{c}O₂₋ₐZ₂ (wherein 0.90≦a≦1.8, 0≦b≦0.5, 0≦c≦0.05, and 0<a<2); LiₐNi_{b}E_{c}G_{d}O₂ (wherein 0.90≦a≦1.8, 0≦b≦0.9, 0≦c≦0.5, and 0.001≦d≦0.1); LiₐNi_{b}CO_{c}Mn_{d}GeO₂ (wherein 0.90≦a≦1.8, 0≦b≦0.9, 0≦c≦0.5, 0≦d≦0.5, and 0.001≦e≦0.1); LiₐNiG_{b}O₂ (wherein 0.90≦a≦1.8 and 0.001≦b≦0.1); LiₐCoG_{b}O₂ (wherein 0.90≦a≦1.8 and 0.001≦b≦0.1); LiₐMnG_{b}O₂ (wherein 0.90≦a≦1.8 and 0.001≦b≦0.1); LiₐMn₂G_{b}O₄ (wherein 0.90≦a≦1.8 and 0.001≦b≦0.1; QO₂); QS₂; LiQS₂; V₂O₅; LiV₂O₅; LiTO₂; LiNiVO₄; Li_{(3-f)}J₂(PO₄)₃ (wherein 0≦f≦2); Li_{(3-f)}Fe₂(PO₄)₃ (wherein 0≦f≦2); and LiFePO₄.

In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co. Ni, Cu, or a combination thereof.

The lithium-containing compound coated with a coating layer, or a mixture of the lithium-containing compound and the lithium-containing compound coated with the coating layer may be used for the positive active material. The coating layer may include at least one coating element compound selected from the group consisting of an oxide of the coating element, a hydroxide of the coating element, an oxyhydroxide of the coating element, an oxycarbonate of the coating element, and a hydroxycarbonate of the coating element. The compound for the coating layer may be amorphous or crystalline. The coating element included in the coating layer may be selected from the group consisting of Mg, Al, Co, K, Na, Ca, Si, Ti, V, Sn, Ge, Ga, B, As, Zr or a mixture thereof. The coating process may include any conventional processes as long as it does not causes any side effects on the properties of the positive active material (e.g., spray coating, immersing), which is well known to persons having ordinary skill in this art, so a detailed description thereof is omitted.

The binder improves binding properties of the positive active material particles to each other and to a current collector. Examples of the binder include polyvinyl alcohol, carboxylmethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butacliene rubber, an acrylated styrene-butadiene rubber, an epoxy resin, nylon, and the like, but are not limited thereto.

The conductive material improves electrical conductivity of a negative electrode, Any electrically conductive material may be used as a conductive agent unless it causes a chemical change. Examples of the conductive material include natural graphite, artificial graphite, carbon black, acetylene black, ketjen black, a carbon fiber, a metal powder or a metal fiber of copper, nickel, aluminum, silver, and the like, and a polyphenylene derivative, which may be used singularly or as a mixture thereof.

The negative electrode 6 includes a current collector and a negative active material layer disposed thereon.

The current collector may include a copper foil, a nickel foil, a stainless steel foil, a titanium foil, a nickel foam, a copper foam, a polymer substrate coated with a conductive metal, and combinations thereof, but is not limited thereto.

The negative active material layer may include a negative active is material, a binder, and optionally a conductive material.

The negative active material includes a material that reversibly intercalates/deintercalates lithium ions, a lithium metal, a lithium metal alloy, a material being capable of doping/dedoping lithium, or a transition metal oxide.

The material that may reversibly intercalate/deintercalate lithium ions includes a carbon material. The carbon material may be any generally-used carbon-based negative active material in a lithium ion rechargeable battery. Examples of the carbon material include crystalline carbon, amorphous carbon, and mixtures thereof. The crystalline carbon may be non-shaped, or sheet, flake, spherical, or fiber shaped natural graphite or artificial graphite. The amorphous carbon may be a soft carbon, a hard carbon, mesophase pitch carbide, fired coke, and the like.

Examples of the lithium metal ahoy include lithium and a metal selected from the group consisting of Na, K, Rb, Cs, Fr, Be, Mg, Ca, Sr, Si, Sb, Pb, In, Zn, Ba, Ra, Ge, Al, and Sn.

Examples of the material being capable of doping lithium include Si, SiOₓ (0<x<2), a SI-Q ahoy (where Q is an element selected from the group consisting of an alkali metal, an alkaline-earth metal, a group 13 element, a group 14 element, a transition element, a rare earth element, and combinations thereof, and is not Si). Sn, SnO₂, a Sn-Q alloy (where Q is an element selected from the group consisting of an alkali metal, an alkaline-earth metal, a group 13 element, a group 14 element, a transition element, a rare earth element, and combinations thereof, and is not Sn) or mixtures thereof. At least one of these materials may be mixed with SiO₂. The element Q may be selected from the group consisting of Mg, Ca, Sr, Ba, Ra, Sc, Y, Ti, Zr, Hf, Rf, V, Nb, Ta, Db, Cr, Mo W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and a combination thereof.

Examples of the transition metal oxide include vanadium oxide, lithium vanadium oxide, and the like.

The binder improves binding properties of negative active material particles with one another and with a current collector. Examples of the binder include polyvinyl alcohol, carboxylmethyl cellulose, hydroxypropyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is included to improve electrode conductivity. Any electrically conductive material may be used as a conductive material unless it causes a chemical change. Examples of the conductive material include carbon-based materials such as natural graphite, artificial graphite, carbon black, acetylene black, ketjen black, carbon fibers, and the like; metal-based materials of metal powder or metal fiber including copper, nickel, aluminum, silver; conductive polymers such as polyphenylene derivatives; or a mixture thereof.

Each of the positive electrode 5 and the negative electrode 6 may be fabricated by a method including mixing an active material, a binder and optionally a conductive material in a solvent to prepare an active material composition and coating the composition on a current collector.

The electrode manufacturing method is well known, and thus is not described in detail in the present specification. The solvent may be N-methylpyrrolidone but it is not limited thereto.

The separator 7 may be formed as a single layer or a multilayer, and may be made of polyethylene, polypropylene, polyvinylidene fluoride, or a combination thereof.

Hereinafter, the embodiments are illustrated in more detail with reference to examples. However, the following are exemplary embodiments and are not limiting.

Furthermore, what is not described in this specification may be sufficiently understood by those who have knowledge in this field and will not be illustrated here.

### (Preparing Electrolyte)

### Example 1

1.0M of LiPF₆ is dissolved into a solution in which ethylene carbonate (EC), ethylmethyl carbonate (EMC), and diethyl carbonate (DEC) are mixed in a volume ratio of: 1:1:1 and then added with 2,4,6-tris(trifluoromethyl)-1,3,5-triazine and fluoroethyl carbonate to provide an electrolyte.

The 2,4,6-tris(trifluoromethyl)-1,3,5-triazine is included at 1 wt % based on the total amount of the electrolyte, and the fluoroethyl carbonate is included at 3 wt % based on the total amount of the electrolyte.

### Example 2

An electrolyte is prepared in accordance with the same process as in Example 1, except that 2,4,6-tris(trifluoromethyl)-1,3,5-triazine is used at 3 wt % based on the total amount of electrolyte.

### Example 3

An electrolyte is prepared in accordance with the same process as in Example 1, except that fluoroethyl carbonate is used at 5 wt % based on the total amount of electrolyte.

### Comparative Example 1

1.0M of LiFT₆ is dissolved into a solution in which ethylene carbonate (EC), ethylmethyl carbonate (EMC), and diethyl carbonate (DEC) are mixed in a volume ratio of 1:1:1 to provide an electrolyte.

### Comparative Example 2

1.0M of LiPF₆ is dissolved into a solution in which ethylene carbonate (EC), ethylmethyl carbonate (EMC), and diethyl carbonate (DEC) are mixed in a volume ratio of 1:1:1 and then added with fluoroethyl carbonate to provide an electrolyte.

The fluoroethyl carbonate is added at 3 wt % based on the total amount of the electrolyte.

### Comparative Example 3

1.0M of LiPF₆ is dissolved into a solution in which ethylene carbonate (EC), ethylmethyl carbonate (EMC), and diethyl carbonate (DEC) are mixed in a volume ratio of 1:1:1 and then added with 2,4,6-tris(trifluoromethyl)-1,3,5-triazine to provide an electrolyte.

The 2,4,6-tris(trifluoromethyl)-1,3,5-trazine is added at 1 wt % based on the total amount of the electrolyte.

### Comparative Example 4

1.0M of LiPF₆ is dissolved into a solution in which ethylene carbonate (EC), ethylmethyl carbonate (EMC), and diethyl carbonate (DEC) are mixed in a volume ratio of 1:1:1 and then added with 2,4,8-tris(trifluoromethyl)-1,3,5-triazine to provide an electrolyte.

The 2,4,6-tris(trifluoromethyl)-1,3,5-triazine is added at 2 wt % based on the total amount of the electrolyte.

### (Fabricating Rechargeable Lithium Battery Cell)

A positive active material of LiNi_{0.5}Co_{0.2}Mn_{0.3}O₂, a binder of polyvinylidene fluoride (PVDF), and a conductive material of carbon are mixed in a weight ratio of 92:4:4 and dispersed in N-methyl-2-pyrrolidone to provide a composition for a positive active material layer. The composition for a positive active material layer is coated on a 20 μm-thick aluminum foil and dried and pressed to provide a positive electrode.

A negative active material of crystalline artificial graphite and a binder of polyvinylidene fluoride (PVDF) are mixed in a weight ratio of 92:8 and dispersed in N-methyl-2-pyrrolidone to provide a composition for a negative active material layer. The composition for a negative active material layer is coated on a 15 μm-thick copper foil and dried and pressed to provide a negative electrode.

The obtained positive electrode and negative electrode and a separator made of 25 μm-thick polyethylene are wound and compressed, and they inserted into a 30 mm×48 mm×6 mm prismatic can, and an electrolyte is injected into provide a rechargeable lithium battery cell. The electrolyte is one obtained from Examples 1 to 3 and Comparative Examples 1 to 4.

### Experimental Example 1

### Measuring Thickness Change of Rechargeable Lithium Battery while being Mowed to Stand at High Temperature

Each rechargeable lithium battery cell using the electrolyte obtained from Examples 1 to 3 and Comparative Examples 1 to 4 is charged under a constant current and constant voltage (CC-CV) condition of a current of 160 mA and a voltage of 4.2V, and then allowed to stand for one hour and discharged at a 160 mA current to 2.75V and allowed to stand for one hour. This process is repeated three times and then the resulting battery cell was fully charged at a 400 mA current and a 4.2V voltage for 2 hours 30 minutes is performed. At this time, the thickness of the battery cell refers to an initial battery thickness.

The fully charged battery cell was allowed to stand at 85° C. for 5 hours.

The thickness increase rate (%) is shown in the following Table 1. The thickness increase rate (%) is defined as 100*[(the battery thickness after allowing to stand at 85)−(the initial battery thickness)]/(the initial battery).

TABLE 1

| | |
|---|---|
| | Comparative |
| Example | Example |

| | 1 | 2 | 3 | 1 | 2 | 3 | 4 |
|---|---|---|---|---|---|---|---|
| Thickness | 12 | 11 | 13 | 21 | 20 | 10 | 8 |
| increase rate (%) | | | | | | | |

As shown in Table 1, rechargeable lithium battery cells using the electrolyte obtained from Examples 1 to 3 including both a triazine-based compound and fluoroethyl carbonate as an additive change somewhat in thickness while being allowed to stand at a high temperature.

On the other hand, the rechargeable lithium battery cell using the electrolyte according to Comparative Example 1 including no additive and that according to Comparative Example 2 including only fluoroethyl carbonate significantly change in thickness during while being allowed to stand at a high temperature.

Comparing the rechargeable lithium battery cell using the electrolyte having 1 wt % of 2,4,6-tris(trifluoromethyl)-1,3,5-triazine according to Comparative Example 3, the rechargeable lithium battery cell using the electrolyte having the same amount of 2,4,6-trifluoromethyl)-1,3,5-triazine shows a better result because of fluoroethyl carbonate.

In addition, comparing the rechargeable lithium battery cell using the electrolyte having 3 wt % of fluoroethyl carbonate according to Comparative Example 2, the rechargeable lithium battery cell using the electrolyte having the same amount of fluoroethyl carbonate shows a better result because of 2,4,6-tris(trifluoromethyl)-1,3,5-triazine.

### Experimental Example 2

### Assessing Cycle-life Characteristic of Rechargeable Lithium Battery

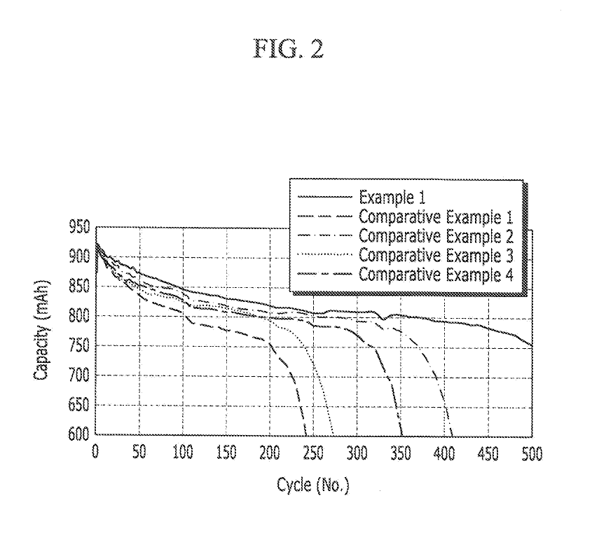

The rechargeable lithium battery cells using the electrolytes obtained from Examples 1 to 3 and Comparative Examples 1 to 4 are measured for cycle-life characteristics according to the following method, and the results are shown in the following Tables 2 and 3 and FIG. 2.

Each rechargeable lithium battery cell using the electrolyte according to Examples 1 to 3 and Comparative Examples 1 to 4 is charged and discharged 500 times. The charging takes place under CC-CV conditions of a 900 mA current and a 4.2 V voltage for 2 hours and 30 minutes, and discharge is performed at a 900 mA current and a 3.2 V voltage,

TABLE 2

| | | | | Comparative | | | |
|---|---|---|---|---|---|---|---|
| | Example | | | Example | | | |
| | 1 | 2 | 3 | 1 | 2 | 3 | 4 |
| Cycle number | 500* | 500* | 500* | 150 | 350 | 200 | 300 |
| Where cycle life | | | | | | | |
| decreases rapidly | | | | | | | |

*Even at 500 cycles, the cycle life in the battery cells according to Examples 1-3 did not decrease rapidly yet. (See FIG. 2.)

FIG. 2 is a graph showing the cycle-ft characteristics of rechargeable lithium battery cells using the electrolytes obtained from Example 1 and Comparative Examples 1 to 4.

Table 3 shows the cycle number when the battery capacity was decreased to 600 mAh. The initial capacity of the battery cell of Example 1 was substantially kept, compared with Comparative Examples 1-4.

TABLE 3

| | Example | Comparative Example | | | |
|---|---|---|---|---|---|
| | 1 | 1 | 2 | 3 | 4 |
| Cycle number | N/A* | 235 | 410 | 270 | 351 |
| when the capacity | | | | | |
| was decreased to | | | | | |
| 600 mAh. | | | | | |

*Even after 500 cycles, the capacity of thebattery cell of Example 1 did not decrease to 600 mAh, and the capacity was kept to 751 mAh. As shown in Tables 2 and 3 and FIG. 2, the rechargeable lithium battery cell using the electrolyte according to Example 1 including both a triazine-based compound and fluoroethyl carbonate as an additive has much better cycle-life characteristics than the rechargeable lithium battery cell using the electrolyte according to Comparative Example 1 including no additive, the rechargeable lithium battery cell using the electrolyte according to Comparative Example 2 including only fluoroethyl carbonate, and the rechargeable lithium battery cells using the electrolytes according to Comparative Examples 3 and 4 including only the triazine-based compound.

As shown in Table 1, the rechargeable lithium battery cells using the electrolytes according to Comparative Examples 3 and 4 change the thickness insignificantly but deteriorate the cycle-life characteristics while being allowed to stand as shown in Tables 2 and 3 and FIG. 2.

On the other hand, the rechargeable lithium battery cell according to one embodiment including both the triazine-based compound and fluoroethyl carbonate suppresses the thickness increase of the batten cell and simultaneously provides excellent cycle-life characteristics while being allowed to stand at a high temperature.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An electrolyte for a rechargeable lithium battery, comprising
a lithium salt;
a non-aqueous organic solvent; and
an additive comprising a triazine-based compound represented by the following Chemical Formula 1 and fluoroethyl carbonate: 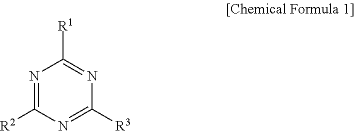
wherein R¹, R², and R³ are the same or different from each other, and are each independently hydrogen, halogen, a substituted or unsubstituted C1 to C20 alkyl group, or a substituted or unsubstituted C1 to C20 haloalkyl group.

2. The electrolyte for a rechargeable lithium battery of claim 1, wherein in Chemical Formula 1, R¹, R², and R³ are independently a substituted or unsubstituted C1 to C20 haloalkyl group.

3. The electrolyte for a rechargeable lithium battery of claim 1, wherein in Chemical Formula 1, R¹, R², and R³ are independently a C1 to C20 perfluoroalkyl group.

4. The electrolyte for a rechargeable lithium battery of claim 1, wherein the triazine-based compound represented by the above Chemical Formula 1 comprises 2,4,6-tris(trifluoromethyl)-1,3,5-triazine, 2,4,6-tris(trichloromethyl)-1,3,5-triazine, or a combination thereof.

5. The electrolyte for a rechargeable lithium battery of claim 1, wherein the triazine-based compound represented by the above Chemical Formula 1 is included in an amount of about 0.1 wt % to about 5 wt % based on the total weight of the electrolyte.

6. The electrolyte for a rechargeable lithium battery of claim 1, wherein the fluoroethyl carbonate is included in an amount of about 0.1 wt % to about 15 wt % based on the total weight of the electrolyte.

7. The electrolyte for a rechargeable lithium battery of claim 1, wherein the triazine-based compound represented by the above Chemical Formula 1 is included in an amount of about 0.1 wt % to about 5 wt % based on the total weight of the electrolyte, and the fluoroethyl carbonate is included in an amount of about 0.1 wt % to about 15 wt % based on the total weight of the electrolyte.

8. The electrolyte for a rechargeable lithium battery of claim 1, wherein the non-aqueous organic solvent comprises a linear carbonate in an amount of at least about 60 wt % based on the total weight of the non-aqueous organic solvent.

9. The electrolyte for a rechargeable lithium battery of claim 1, wherein the non-aqueous organic solvent comprises a cyclic carbonate hi an amount of about 40 wt % or less than based on the total weight of the non-aqueous organic solvent.

10. A rechargeable lithium battery, comprising:
a positive electrode;
a negative electrode; and
an electrolyte comprising a lithium salt, a non-aqueous organic solvent, and an additive comprising a triazine-based compound represented by the following Chemical Formula 1 and fluoroethyl carbonate: 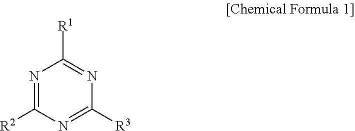
wherein R¹, R², and R³ are the same or different from each other, and are hydrogen, halogen, a substituted or unsubstituted C1 to C20 alkyl group, or a substituted or unsubstituted C1 to C20 haloalkyl group.

11. The rechargeable lithium battery of claim 10, wherein the negative electrode comprises:
a current collector; and
a negative active material layer comprising a negative active material disposed on the current collector, the negative active material comprising a carbon-based compound.

12. The rechargeable lithium battery of claim 10, wherein in Chemical Formula 1, R¹, R², and R³ are independently a C1 to C20 perfluoroalkyl group.

13. The rechargeable lithium battery of claim 10, wherein the triazine-based compound represented by the above Chemical Formula 1 comprises 2,4,6-tris(trifluoromethyl)-1,3,5-triazine, 2,4,6-tris(trichloromethyl)-1,3,5-triazine, or a combination thereof.

14. The rechargeable lithium battery of claim 10, wherein the triazine-based compound represented by the above Chemical Formula 1 is included in an amount of about 0.1 wt % to about 5 wt % based on the total weight of the electrolyte.

15. The rechargeable lithium battery of claim 10, wherein the fluoroethyl carbonate is included in an amount of about 0.1 wt % to about 15 wt % based on the total weight of the electrolyte.

16. The rechargeable lithium battery of claim 10, wherein the non-aqueous organic solvent comprises a linear carbonate in an amount of at least about 60 wt % based on the total weight of the non-aqueous organic solvent.

17. The rechargeable lithium battery of claim 10, wherein the non-aqueous organic solvent comprises a cyclic carbonate in an amount of about 40 wt % or less than based on the total weight of the non-aqueous organic solvent.

18. A rechargeable lithium battery, comprising:
a positive electrode:
a negative electrode; and
an electrolyte comprising a lithium salt, a non-aqueous organic solvent, and an additive comprising a triazine-based compound represented by the following Chemical Formula 1 and fluoroethyl carbonate: 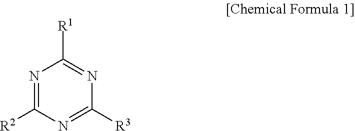
wherein R¹, R², and R³ are the same or different from each other, and are hydrogen, halogen, a substituted or unsubstituted C1 to C20 alkyl group, or a substituted or unsubstituted C1 to C20 haloalkyl group; and
the triazine-based compound represented by the above Chemical Formula 1 is included in an amount of about 0.1 wt % to about 5 wt % based on the total weight of the electrolyte, and the fluoroethyl carbonate is included in an amount of about 0.1 wt % to about 15 wt % based on the total weight of the electrolyte.

19. The rechargeable lithium battery of claim 17, wherein in Chemical Formula 1, R¹, R², and R³ are each independently a substituted or unsubstituted C1 to C20 haloalkyl group.

20. The rechargeable lithium battery of claim 17, wherein the triazine-based compound represented by the above Chemical Formula 1 comprises 2,4,6-tris(trifluoromethyl)-1,3,5-triazine, 2,4,6-tris(trichloromethyl)-1,3,5-triazine, or a combination thereof.
